(19) United States
(12) Patent Application Publication
(10) Pub. No.: US 2002/0149311 A1
(43) Pub. Date: Oct. 17, 2002

(54) LUMINESCENT SCREEN WITH LUMINESCENT MATERIAL COMPOSITION CONTAINING AN OXIDE

(76) Inventors: THOMAS JUSTEL, AACHEN (DE); HANS NIKOL, AACHEN (DE); JACQUELINE MERIKHI, AACHEN (DE)

Correspondence Address: U S PHILIPS CORPORATION, 580 WHITE PLAINS ROAD, TARRYTOWN, NY, 10591

(21) Appl. No.: 09/436,179

(22) Filed: Nov. 8, 1999

(30) Foreign Application Priority Data
Nov. 6, 1998 (DE) 19851348.8

(51) Int. Cl. H01J 1/62

(52) U.S. Cl. 313/483

(57) ABSTRACT

A luminescent screen, particularly a plasma display screen, with a luminescent material composition comprising a luminescent material with a coating comprising MgO is characterized in that the ignition voltage of the plasma is reduced by the high secondary electron emission so that low-cost drive electronics can be used for the luminescent screen.

The invention relates to a luminescent screen, particularly a plasma display screen, with a luminescent material composition comprising a luminescent material with a coating.

A plasma display screen usually consists of two parallel glass substrates provided with electrode arrays: horizontal scan and sustain electrodes on the front plate and vertical data electrodes on the backplate. An electric voltage at given row or column electrodes ensures pixel-precise discharges of an enclosed gas so that plasma is built up. The discharge locations between the plates, which are decisive for single pixels, are separated from each other by a rib structure. The luminescent material pixels are located in the cells constituted by the ribs.

The plasma emits ultraviolet photons which causes the luminescent materials to emit red, green or blue light exactly at the desired spot in the grid network of the electrodes.

The light-emissive discharges are dielectrical barrier discharges and last only a few nanoseconds. For the temporal limitation, thin dielectric coatings provided on both electrode arrays are suitable. They stop the gas ions produced at the cathode and the electrons at the anode.

Prior plasma display screens operate at a DC voltage of approximately 360 V. The electrodes directly drive the plasma and the signals have a very simple form, but such displays did not have a very long lifetime because the electrodes and luminescent materials were constantly subjected to an ion bombardment. In the case of AC voltage operation, the electrodes are provided with a non-conducting coating of magnesium oxide which operates as a capacitor arranged in series with the discharge path. Thus protected, electrodes and luminescent materials have a longer lifetime. The signal waveform of the drive voltages is more complicated in this case. The voltage once built up at the capacitor may, however, be added to the drive voltage at the next ignition so thatconsiderably lower operating voltage is sufficient, which has a favorable effect on the costs of the drivers. If the ignition voltage can be further reduced, the drive electronics would even be considerably less expensive.

A fluorescent material for illumination purposes which can be excited by Xe₂ excimer radiation emitting in the VUV spectral region, is known from U.S. Pat. No. 5,714,835. The material comprises a host grid and at least one doping comprising at least an activator and luminescing in the visible range of the optical spectrum, in which, for an efficient excitation by the Xe₂ excimer radiation, the fluorescent material comprises a red-fluorescing material R of a mixed borate defined by the general formula (Yₓ,Gd_{y},Eu_{z})Bo₃, with 0≦x≦0.99, 0≦y≦0.99, 0.01≦z≦0.2 and x+y+z=1, a green-fluorescing material G of a mixed phosphate defined by the general formula (Ln_{w}Ce_{y}Sc_{w}Tb_{z})PO₄ with 0.35≦x≦0.95, 0≦y≦0.5, 0≦w≦0.2, 0.05≦z≦0.5 and w+x+y+z=1, in which Ln is one of the elements La, Y or Gd or a mixture of these elements, and a blue-fluorescing material B of a mixed aluminate defined by the general formula (Baₓ,Eu_{y})MgAl₁₀O₁₇ with 0.6≦x≦0.97, 0.03≦y≦0.4 and x+y+z=1, and the parts by weight in the mixture are 0.21R<0.5, 0.4<G<0.7, 0.05<B<0.15 and R+G+B=1, with a protective coating on the fluorescent material, comprising MgF₂.

It is an object of the invention to provide a luminescent screen with a luminescent material composition which, inter alia, has a low operating voltage, a long lifetime and a higher efficiency.

According to the invention, the object is solved by a luminescent screen with a luminescent material composition comprising a luminescent material with at least one coating, which coating comprises magnesium oxide MgO.

The invention is based on the recognition that the plasma discharge is not independent of the luminescent material. A luminescent material composition in which the luminescent material is provided with a magnesium oxide-containing coating, reduces the ignition voltage of the plasma by the high secondary electron emission and therefore allows use of less expensive drive electronics for the luminescent screen.

It was surprisingly found that a coating comprising a magnesium oxide MgO also has the effect of a stabilizing protective coating which reduces the decrease of efficiency of UV luminescent materials with respect to time under UV excitation. Moreover, the coating according to the invention inhibits the shift of the color point under UV excitation. Consequently, these luminescent screens remain bright and rich in contrast for a long time. The magnesium oxide constitutes a hard water-insoluble coating on the luminescent material particles, does not react with the VUV luminescent materials and is not degraded by radiation.

Since magnesium oxide itself is colorless, it neither influences the chrominance values of the luminescent materials. The magnesium oxide-containing coating is hydrophilic so that the coated particles can be easily dispersed.

The relatively low solubility product of Mg(OH)₂ (k_{L}=1.2×10⁻¹¹) and the low hydrolysis tendency of MgO contributes to the stabilization of the luminescent material composition which is thereby insensitive to aqueous solutions. This is of great importance because, for environmental reasons, an increasing number of water-based luminescent material suspensions are increasingly used in the manufacture of display screens and lamps.

Within the scope of the present invention it is preferable that the coating consists of magnesium oxide MgO.

It is also preferable that the luminescent material is a vacuum-UV luminescent material.

The invention also relates to a method of manufacturing a luminescent material composition comprising a luminescent material with at least one coating comprising magnesium oxide MgO from a suspension of the luminescent material in a solution having a pH of 7, comprising Mg(NO₃)₂ by precipitation of magnesium oxide MgO by raising the pH-value to 9.5.

Since amorphous MgO already starts absorbing at wavelengths of less than 220 nm and thus absorbs the light emitted by a xenon plasma (predominantly 172 nm at higher Xe partial pressure) itself, the thickness of the coating for the light output of the coated luminescent material is decisive. Due to the novel method of homogeneous precipitation of Mg(OH)₂ and the subsequent calcination step for a complete dehydration of Mg(OH)₂ to MgO, as described hereinafter, dense and very thin coatings with a thickness of between 5 and 20 nm are obtained.

The invention will hereinafter be described with reference to an embodiment.

The luminescent materials which, in accordance with the invention, are provided with a stabilizing magnesium oxide-containing coating are not subject to any limitation. For example, the following luminescent materials may be used: LaPO₄:Ce, BaSi₂O₅:Pb, (Sr,Zn)₂MgSi₂O₇:Pb, Y₂SiO₅:Ce, BaMgAl₁₀O₁₇:Eu, BaMgAl₁₄O₂₃:Eu, BaMgAl₁₀O₁₇:Eu,Mn, Zn₂SiO₄:Mn, ZnGa₂O₄:Mn, BaAl₁₂O₁₉:Mn, LaPO₄:Ce,Tb, (Ce,Tb)MgAl₁₁O₁₉, (Ce,Gd,Tb)MgB₅O₁₀, Y₃(Al,Ga)₅O₁₂:Ce, Y₂O₃:Eu, (Y,Gd)₂O₃:Eu, Ba(Gd,Y)B₉O₁₆:Eu, (Me1,Me2)BO₃:Eu with Me1, Me2=Y, Lu, Gd, In, La, Sc, Bi, Mg₄GeO_{5.5}F:Mn. BaMgAl₁₀O₁₇:Eu (BAM) is preferred as a blue-luminescing material, (Sr,Zn)₂MgSi₂O₇:Pb (SMS) is preferred as a green-luminescing material and Y₂O₃:Eu (YOX) is preferred as a red-luminescing material.

The particles of the luminescent materials are coated with a thin and even coating comprising magnesium oxide MgO. The coating thickness is usually 5 to 20 nm and is thus so thin that the UV absorption of the coating can be ignored.

The coating may also comprise, for example organic and inorganic binders such as latex, methyl cellulose, aluminum phosphate or SiO₂ so as to limit the possibility of chemical attacks on the luminescent material particles.

In addition to the magnesium oxide-containing coating, the luminescent material composition may also comprise further coatings, for example, with pigments influencing the chrominance value of the luminescent material.

As a basic compound for the coating, a water-soluble magnesium salt, particularly a water-soluble nitrate, acetate or perchlorate is used.

To manufacture the coating solution, one or more of these magnesium salts are dissolved in water and the pH-value is set at 7. The luminescent material to be coated is dispersed in this solution. The aqueous luminescent material suspension thus produced is maintained in contact with an ammonia-containing atmosphere while stirring, until the pH-value of the suspension has increased to 9.5 and Mg(OH)₂ is precipitated on the luminescent material particles. The Mg(OH)₂-coated luminescent material is filtered off, dried and subsequently calcinated at a raised temperature so that Mg(OH)₂ is converted into MgO.

A mechanically and chemically very resistant magnesium oxide-containing coating which fixedly adheres to the luminescent material particles is obtained by this method.

The coating thus produced usually has a coating thickness of 5 to 20 nm and completely covers the luminescent material particles.

The coating is hydrophilic and is satisfactorily compatible with the usual luminescent material coatings so that it is suitable as a basic coating for further coatings which may subsequently be provided so as to improve the powder properties or the chrominance values of the luminescent materials.

The luminescent material composition is provided on the luminescent display screen in accordance with the known methods.

### Embodiment

SMS:MgO

1.0 g of Mg(NO₃)₂ 6H₂O (3.9 mmol) were dissolved in 50 ml water. 8.0 g of SMS were suspended in 50 ml of water and subsequently the magnesium nitrate solution was added to this suspension. The suspension obtained with a pH-value of 7.5, present in a flask, was stirred vigorously. Subsequently, the flask was connected via a glass tube joint to a second flask containing a concentrated ammonia solution. After approximately 2 hours, the pH-value of the suspension had risen to pH 9.1 so that the precipitation of Mg(OH)₂ started. Subsequently, after further stirring the pH-value rose to approximately pH 9.5. Then the coated luminescent material was filtered off, dried at 80° C. and finally calcinated for 2 hours at 450° C.

TABLE 1
Optical properties of SMS and SMS:MgO

| Luminescent | | | | |
|---|---|---|---|---|
| material | λₘₐₓ [nm] | LE [lm/W] | QE₂₅₄ [%] | RQ₂₅₄ [%] |
| SMS | 365 | 15 | 89 | 8 |
| SMS:MgO | 365 | 15 | 91 | 9 |

### YOX:MgO

The coating process proceeded analogously to the first process. Luminescent screens with the coated luminescent material showed a clearly lower ignition voltage than screens manufactured with uncoated YOX.

TABLE 2
Optical properties of YOX and YOX:MgO

| Luminescent | | | | |
|---|---|---|---|---|
| material | λₘₐₓ [nm] | LE [lm/W] | QE₂₅₄ [%] | RQ₂₅₄ [%] |
| YOX | 611 | 288 | 88 | 15 |
| YOX:MgO | 611 | 288 | 88 | 17 |

### BAM: MgO

The coating process proceeded analogously to the first process. Luminescent screens with the coated luminescent material showed a clearly lower ignition voltage than screens manufactured with uncoated BAM.

TABLE 3
Optical properties of BAM and BAM:MgO

| Luminescent | | | | |
|---|---|---|---|---|
| material | λₘₐₓ [nm] | LE [lm/W] | QE₂₅₄ [%] | RQ₂₅₄ [%] |
| BAM | 450 | 90 | 90 | 8 |
| BAM:MgO | 450 | 91 | 96 | 9 |

As shown in the embodiment, the ignition voltage is clearly decreased in the case of dielectrical barrier discharges so that the costs of high-voltage electronics are also decreased. Surprisingly, magnesium oxide-containing coatings also increase the reflection of the phosphor in the visible spectral range and hence also its quantum efficiency so that they may be of great interest also for Hg discharge lamps. Moreover, the problem of UV absorption by the magnesium oxide-containing coating occurs in this case only to a reduced extent (185 nm line).

1. A luminescent screen with a luminescent material composition comprising a luminescent material with a coating characterized in that
the coating comprises magnesium oxide MgO.

2. A luminescent screen as claimed in claim 1, characterized in that
the coating consists of magnesium oxide MgO.

3. A luminescent screen as claimed in claim 1, characterized in that the luminescent material is a vacuum-UV luminescent material.

4. A method of manufacturing a luminescent material composition comprising a luminescent material with a coating comprising magnesium oxide MgO from a suspension of the luminescent material in a solution having a pH of 7, comprising a magnesium salt which is soluble in water, by homogeneous precipitation of magnesium oxide Mg(OH)₂ on the luminescent material by raising the pH-value to 9.5 and by subsequent calcination of the luminescent material coated with Mg(OH)₂.
